(19) United States
(12) Patent Application Publication
(10) Pub. No.: US 2024/0266093 A1
(43) Pub. Date: Aug. 8, 2024

(54) RESISTOR, METHOD OF MANUFACTURING SAME, AND DEVICE INCLUDING RESISTOR

(71) Applicant: SEMITEC Corporation, Tokyo (JP)

(72) Inventor: Masahiro KANAMORI, Tokyo (JP)

(73) Assignee: SEMITEC Corporation, Tokyo (JP)

(21) Appl. No.: 18/291,566

(22) PCT Filed: Jul. 25, 2022
(86) PCT No.: PCT/JP2022/028612

§ 371 Date: Jan. 23, 2024

(30) Foreign Application Priority Data
Aug. 6, 2021 (JP) 2021-129738

(51) Int. Cl. H01C 1/14; H01C 7/18; H01C 17/28

(52) U.S. Cl. CPC H01C 1/14; H01C 7/18; H01C 17/28

(57) ABSTRACT

Provided are a resistor that is compact, highly accurate, and highly reliable, a method of manufacturing the same, and a device including the resistor. A resistor (10) includes: an insulating substrate (1); a terminal electrode (2) formed on the insulating substrate (1); a bottom electrode (3) that is formed on the insulating substrate (1), is connected to the terminal electrode (2), and has a resistance adjustment pattern (43), and in which a portion thereof that is closer to the terminal electrode (2) has lower resistance than a portion thereof that is farther from the terminal electrode (2); a resistance body (6) formed on the bottom electrode (3); and a top electrode (7) that is formed on the resistance body (6) and is disposed opposite to the bottom electrode (3).

### TECHNICAL FIELD

The present invention relates to a resistor such as a high-accuracy resistor and a heat-sensitive resistor, a method of manufacturing the resistor, and a device including the resistor.

### RELATED ART

Thermistor temperature sensors are used in various industrial fields as heat-sensitive resistors to detect temperature. However, the resistance value shown by a thermistor used as a heat-sensitive resistor depends on the constituent materials of the thermistor, the mixing ratio of the materials, the manufacturing conditions, and the size. Therefore, the resistance value shown by the thermistor tends to vary.

In order to correct and reduce variations in the resistance value shown by the thermistor, a trimming method has been employed to cut off a part of the electrode surface or the thermistor body of the thermistor by laser irradiation and sandblasting methods.

In addition, high-accuracy resistors or the like are applied to high-accuracy current sensors or the like.

### CITATION LIST

### Patent Documents

[Patent Document 1] Japanese Patent No. 2889422
[Patent Document 2] Japanese Patent Application Laid-Open No. 2001-35705
[Patent Document 3] Japanese Patent Application Laid-Open No. 2003-1739901
[Patent Document 4] Japanese Patent Application Laid-Open No. 2017-92232

### SUMMARY OF INVENTION

### Technical Problem

For example, in the medical field, the thermistor used in compact and highly accurate temperature sensors is required to have a low resistance value. In this case, due to the low resistance value, the resistance of the wiring pattern connected to the thermistor is affected, causing a problem that the characteristic curve of the thermistor shifts.

In view of the above, the present invention provides a compact, highly accurate, and highly reliable resistor, a method of manufacturing the same, and a device including the resistor.

### Solution to Problem

A resistor according to an embodiment of the present invention includes: an insulating substrate; a terminal electrode formed on the insulating substrate; a bottom electrode formed on the insulating substrate, connected to the terminal electrode, and including a resistance adjustment pattern, in which a pattern in a region close to the terminal electrode has lower resistance than a pattern in a region far from the terminal electrode; a resistance body formed on the bottom electrode; and a top electrode formed on the resistance body and arranged to face the bottom electrode.

According to the invention, it is possible to provide a compact, highly accurate, and highly reliable resistor. It should be noted that the resistor may include a resistance body regardless of the characteristics, and includes a resistance body that simply has electrical resistance, a thermistor that has a negative temperature coefficient or a positive temperature coefficient, and the like.

A device including a resistor according to an embodiment of the present invention is provided with the resistor.

The resistor can be suitably provided and applied to various devices that require highly accurate control, such as the medical field, in-vehicle devices such as automobiles, and home appliances. There is no particular limitation on the devices to which the present invention is applied.

A method of manufacturing a resistor according to an embodiment of the present invention includes: preparing in advance a plurality of patterns for the top electrode, and selecting the top electrode of a desired pattern from the plurality of patterns of the top electrode to adjust a resistance value; and cutting the resistance adjustment pattern of the bottom electrode to adjust the resistance value.

### Effects of Invention

According to embodiments of the present invention, it is possible to provide a compact, highly accurate, and highly reliable resistor, a method of manufacturing the same, and a device including the resistor.

### BRIEF DESCRIPTION OF DRAWINGS

FIG. 1 is a plan view showing the resistor according to an embodiment of the present invention.

FIG. 2 is a cross-sectional view taken along the line X-X in FIG. 1.

FIG. 3 is a plan view showing the bottom electrode in the same resistor.

FIG. 4 is a plan view showing the bottom electrode, the resistance body, and the top electrode in the same resistor, and a plan view showing a case where these are stacked to form the resistor.

FIG. 5 is a graph showing the temperature of each part in the same resistor.

FIG. 6 is an explanatory diagram showing the relationship of the opposing area between the bottom electrode and the top electrode in the same resistor.

FIG. 7 is a graph showing the change rate of the resistance value due to a change in the opposing area between the bottom electrode and the top electrode in the same resistor.

FIG. 8 is a plan view showing a plurality of patterns of the top electrode in the same resistor.

FIG. 9 is an explanatory diagram showing the method of selecting the pattern of the top electrode in the same resistor to adjust the resistance value.

### DESCRIPTION OF EMBODIMENTS

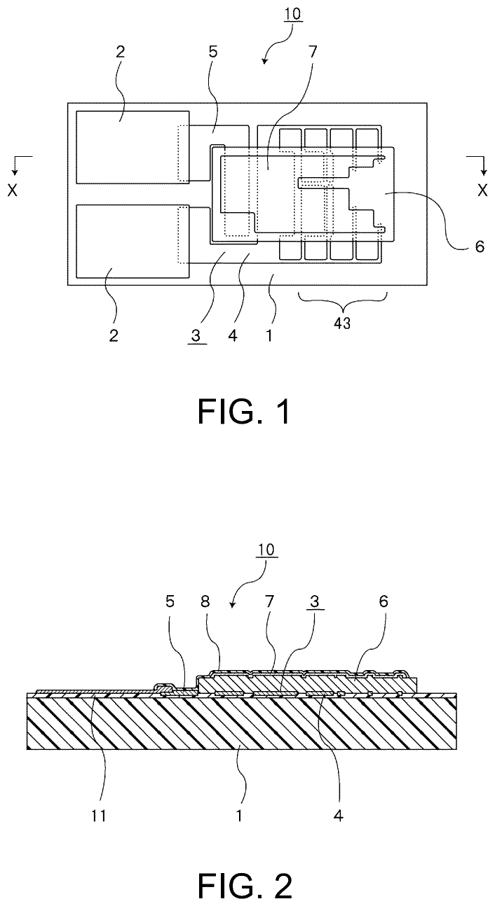

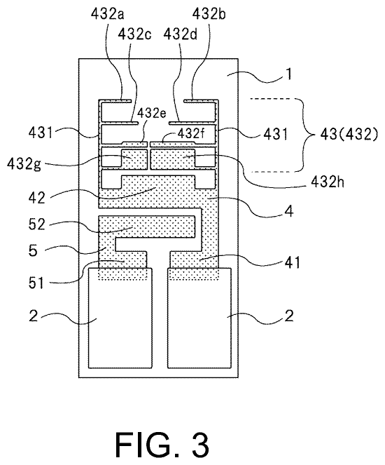

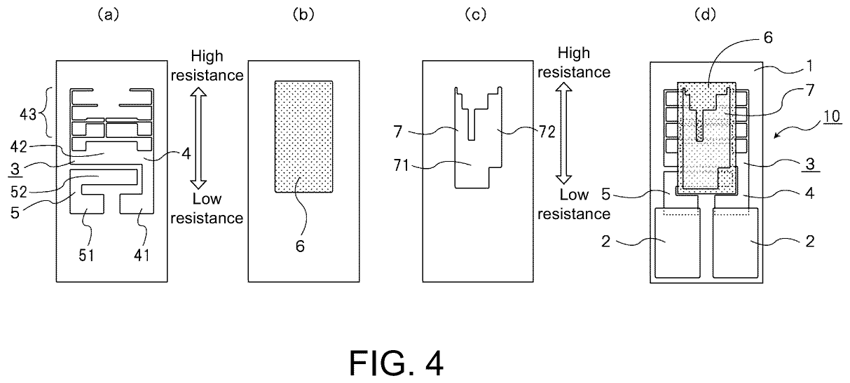

Hereinafter, a resistor according to an embodiment of the present invention will be described with reference to FIG. 1 to FIG. 4. FIG. 1 is a plan view showing the resistor, FIG. 2 is a cross-sectional view taken along the line X-X in FIG. 1, and FIG. 3 is a plan view showing a bottom electrode in the resistor. FIG. 4 is a plan view showing the bottom electrode, a resistance body, and a top electrode, and a plan view of a case where these are stacked to form the resistor. It should be noted that in each drawing, the scale of each member is changed as appropriate so that each member has a recognizable size.

As shown in FIG. 1 and FIG. 2, the resistor 10 includes an insulating substrate 1, a terminal electrode 2, a bottom electrode 3, a resistance body 6, and a top electrode 7. The resistor 10 is configured with the bottom electrode 3 formed on the insulating substrate 1, the resistance body 6 stacked on the bottom electrode 3, and the top electrode 7 stacked on the resistance body 6.

In this embodiment, the resistor 10 is a heat-sensitive resistor and is a thin film thermistor. The resistor may include a resistance body regardless of the characteristics, and includes a resistance body that simply has electrical resistance, a thermistor that has a negative temperature coefficient or a positive temperature coefficient, and the like.

The resistor 10 is formed in a substantially rectangular parallelepiped shape, with a horizontal dimension of 0.8 mm, a vertical dimension of 0.4 mm, and a total thickness of about 50 μm. The shape and dimensions are not particularly limited and can be appropriately selected depending on the application.

The insulating substrate 1 has a substantially rectangular shape and is made of an insulating ceramic material such as zirconia, silicon nitride, alumina, or a mixture of at least one of these. This insulating substrate 1 is formed to have a thickness of 100 μm or less, specifically, thinned to 10 μm to 100 μm, preferably 80 μm or less. Further, an insulating film 11 is formed on one surface (front surface) of the insulating substrate 1. The thickness of the substrate needs to be reduced for use as a highly sensitive temperature sensor, but not necessarily so for use as a resistor.

The terminal electrode 2 has a substantially rectangular pattern to which a lead wire (not shown) is connected. The terminal electrodes 2 are formed in pair on one end side of the insulating substrate 1. The terminal electrodes 2 are portions to which the bottom electrode 3 is electrically connected, and are arranged to face each other with a predetermined interval. In detail, the pair of terminal electrodes 2 are formed by forming a metal thin film by a sputtering method, and the metal material thereof may be noble metals such as platinum (Pt), gold (Au), silver (Ag), and palladium (Pd), and alloys thereof such as an Ag—Pd alloy.

The bottom electrode 3 is a wiring pattern as an electrode pattern formed on the insulating substrate 1, as shown with reference to FIG. 3, and is electrically connected to the terminal electrode 2. Further, the bottom electrode 3 includes a first electrode pattern 4 and a second electrode pattern 5, and the first electrode pattern 4 and the second electrode pattern 5 are electrically connected to the resistance body 6.

The first electrode pattern 4 has a connection pattern 41, a main electrode pattern 42, and a resistance adjustment pattern 43. The connection pattern 41 is a substantially rectangular pattern formed on the side of the terminal electrode 2 and connected to the terminal electrode 2. The connection pattern 41 extends toward the other end side and is electrically connected to the main electrode pattern 42. The main electrode pattern 42 is a pattern formed in a substantially rectangular shape in the width direction of the insulating substrate 1, that is, in the direction perpendicular to the longitudinal direction, and has a relatively wide area together with the connection pattern 41.

The resistance adjustment pattern 43 is a pattern for trimming, and this pattern is appropriately cut by laser trimming to adjust the resistance value, thereby reducing and correcting variations in the resistance value shown by each resistor 10.

The resistance adjustment pattern 43 is formed in a ladder shape and includes support portions 431 formed from both sides of the main electrode pattern 42 in the longitudinal direction, and a plurality of crosspiece portions (ladder portions) 432 formed inward from the support portions 431 in the width direction. Specifically, a total of eight crosspiece portions 432 are provided, four on each side. The crosspiece portions 432 (432a to 432h) are arranged to face each other in pairs, and furthermore, the crosspiece portions 432 are formed to have different lengths and widths and different areas.

In detail, in the drawing (FIG. 3), the crosspiece portions 432 (432a, 432c, 432e, 432g) on the opposing left side are formed to be shorter in length in the inward direction than the crosspiece portions 432 (432b, 432d, 432f, 432h) on the right side, and furthermore, the crosspiece portions 432 on the left side and the crosspiece portions 432 on the right side have different widths in the longitudinal direction on each side. That is, overall, the area of the region of the crosspiece portion 432 that is away from the side of the terminal electrode 2 and far from the terminal electrode 2 is formed to be narrower than the area of the region of the crosspiece portion 432 that is close to the side of the terminal electrode 2. In other words, the area of the region of the crosspiece portion 432 that is close to the side of the terminal electrode 2 is formed to be wider than the area of the region of the crosspiece portion 432 that is far from the terminal electrode 2. Furthermore, the area of the region of the crosspiece portion 432 changes to become gradually narrower stepwise from the region of the crosspiece portion 432 close to the side of the terminal electrode 2 to the region of the crosspiece portion 432 far away. For example, the area of the crosspiece portion 432h is formed to be wider than the areas of the other crosspiece portions 432, and the area of the crosspiece portion 432e is formed to be wider than the areas of the crosspiece portions 432a to 432d.

The second electrode pattern 5 has a connection pattern 51 and a main electrode pattern 52. The connection pattern 51 forms a pair with the connection pattern 41 of the first electrode pattern 4, and like the connection pattern 41, the connection pattern 51 is a substantially rectangular pattern formed on the side of the terminal electrode 2 and electrically connected to the terminal electrode 2.

The connection pattern 51 extends slightly toward the other end side and is electrically connected to the main electrode pattern 52. The main electrode pattern 52 is a pattern formed in a substantially rectangular shape in the width direction of the insulating substrate 1, and has a relatively wide area together with the connection pattern 51. Further, the main electrode pattern 52 faces the main electrode pattern 42 in the first electrode pattern 4 with a predetermined insulation distance, and is arranged to be surrounded by the main electrode pattern 42 and the connection pattern 41 of the first electrode pattern 4.

The bottom electrode 3 is formed by forming a metal thin film by a sputtering method, and the metal material thereof may be noble metals such as platinum (Pt), gold (Au), silver (Ag), and palladium (Pd), and alloys thereof such as an Ag—Pd alloy.

The bottom electrode 3 as described above is configured so that the pattern in the region close to the terminal electrode 2 has a wider area and a lower resistance value than the pattern in the region far away from the terminal electrode 2. That is, the pattern in the region close to the terminal electrode 2 has a wide area and low resistance, and the pattern in the region far away from the terminal electrode 2 has a narrow area and high resistance. Therefore, the influence of the wiring resistance due to the bottom electrode 3 on the characteristics of the resistor 10 can be suppressed.

FIG. 4 shows a case where the resistor 10 is formed by stacking the bottom electrode 3, the resistance body 6, and the top electrode 7 one on top of the other. (a) of FIG. 4 shows the pattern of the bottom electrode 3, (b) of FIG. 4 shows the pattern of the resistance body 6, and (c) of FIG. 4 shows the pattern of the top electrode 7. Further, (d) of FIG. 4 shows a state where the resistor 10 is formed by overlapping and stacking these.

In FIG. 1 and FIG. 2, as shown with reference to FIG. 4, the resistance body 6 is a resistive film and a heat-sensitive thin film. Specifically, the resistance body 6 is a thermistor thin film made of an oxide semiconductor having a negative temperature coefficient. The resistance body 6 is formed in a substantially rectangular shape, and is formed into a film on the bottom electrode 3 by a sputtering method. In detail, the resistance body 6 is stacked to include the main electrode pattern 42 and the resistance adjustment pattern 43 of the first electrode pattern 4, and include and cover the main electrode pattern 52 of the second electrode pattern 5.

The resistance body 6 is composed of two or more elements selected from transition metal elements such as manganese (Mn), nickel (Ni), cobalt (Co), and iron (Fe), and is composed of a thermistor material that includes a composite metal oxide with a spinel structure as the main component. In addition, subcomponents may be included to improve the characteristics. The composition and content of the main component and subcomponents can be determined as appropriate according to the desired characteristics.

Metal oxides (for example, RuO2, SnO, ZnO, Cu2O, CuO, NiO, or the like), metal nitrides (TaN, or the like), and metal films (NiCr, or the like) can be used as the material of the resistance body.

Metal oxides (for example, composite oxides composed of two or more elements such as manganese, nickel, iron, cobalt, copper, silicon, and aluminum) and metal nitrides (for example, composite nitrides composed of two or more elements such as Ta, Nb, Cr, Ti, Zr, Al, and Si can be used as the material of the thermistor.

The top electrode 7 is a wiring pattern as an electrode pattern, is formed into a film by a sputtering method on the resistance body 6 to face the bottom electrode 3, is formed to sandwich the resistance body 6 with the bottom electrode 3, and is electrically connected to the resistance body 6. Further, the top electrode 7 includes a trimming pattern 71 and an opposing pattern 72 that faces the resistance adjustment pattern 43 of the bottom electrode 3. The trimming pattern 71 has a relatively wide area, and therefore is configured so that the region of the trimming pattern 71 close to the terminal electrode 2 has a wider area and a lower resistance value than the region of the opposing pattern 72 far away from the terminal electrode 2.

In detail, the top electrode 7 is stacked to oppose within the substantially rectangular region of the resistance body 6 and include the main electrode pattern 42 and the resistance adjustment pattern 43 of the first electrode pattern 4 in the bottom electrode 3, and include and cover the main electrode pattern 52 of the second electrode pattern 5. The trimming pattern 71 has a substantially quadrilateral shape, forms a pattern with a part on the side of the terminal electrode 2 (lower right corner in (c) of FIG. 4) cut out, and faces the main electrode pattern 42 in the first electrode pattern 4 and the main electrode pattern 52 in the second electrode pattern 5 of the bottom electrode 3. Further, the opposing pattern 72 has left and right patterns, and is formed in a step-like manner so that the area of the region thereof decreases as the opposing pattern 72 extends far away from the terminal electrode 2. In addition, the areas of the left and right patterns are different, and for example, the area of the region of the right pattern is formed wider than the area of the left pattern. The opposing pattern 72 faces the resistance adjustment pattern 43 in the first electrode pattern 4 of the bottom electrode 3.

The top electrode 7 is formed by forming a metal thin film by a sputtering method in the same way as the bottom electrode 3, and the metal material thereof may be noble metals such as platinum (Pt), gold (Au), silver (Ag), and palladium (Pd), and alloys thereof.

Furthermore, as shown in FIG. 2, a protective film 8 is formed to cover the region where the resistance body 6 is formed. The protective film 8 is formed to cover the top electrode 7, the resistance body 6, and the bottom electrode 3, and at least cover the connection portion between the bottom electrode 3 and the terminal electrode 2. In addition, the protective film 8 may be formed by forming silicon dioxide, silicon nitride, or the like into a film by a sputtering method, or forming lead glass, borosilicate glass, lead borosilicate glass, or the like by a printing method.

The resistor 10 according to this embodiment as described above is capable of adjusting the resistance value by correcting variations in the resistance value exhibited by the resistor 10. Specifically, the resistance value of the resistor 10 is adjusted by adjusting the opposing area between the bottom electrode 3 and the top electrode 7, as described later. Further, a plurality of patterns are prepared in advance for the top electrode 7. Therefore, the adjustment of the resistance value is performed by appropriately cutting the resistance adjustment pattern 43 to adjust the resistance value, and by selecting a desired pattern of the top electrode 7 from the plurality of patterns of the top electrode 7 to adjust the resistance value.

Also, in this case, in the bottom electrode 3, the pattern in the region close to the terminal electrode 2 is configured to have a wider area and a lower resistance value than the pattern in the region far away from the terminal electrode 2. Therefore, the influence of the wiring resistance due to the bottom electrode 3 on the characteristics of the resistor 10 can be suppressed.

Furthermore, in the top electrode 7, the region of the trimming pattern 71 close to the terminal electrode 2 is also configured to have a wider area and a lower resistance value than the region of the opposing pattern 72 far away from the terminal electrode 2. Therefore, the influence of the wiring resistance due to the top electrode 7 on the characteristics of the resistor 10 can be suppressed.

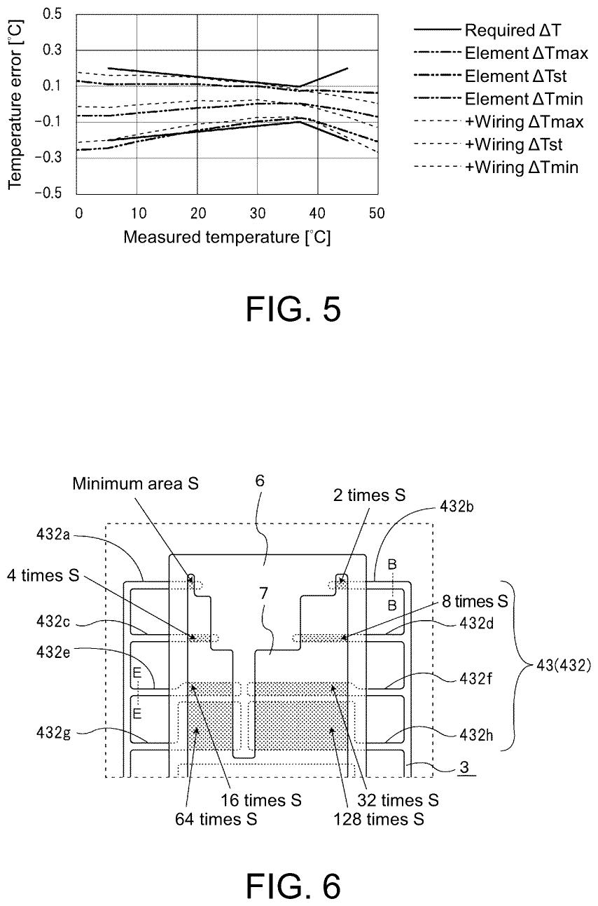

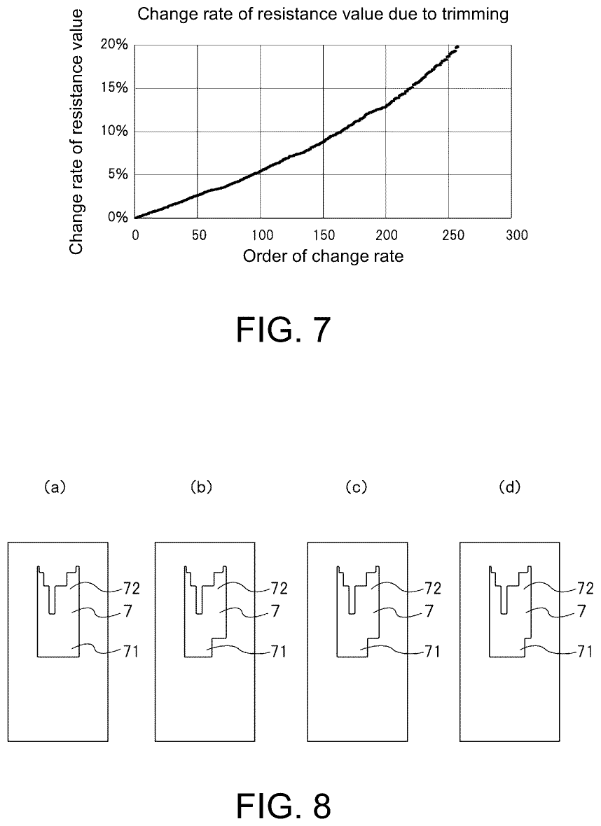

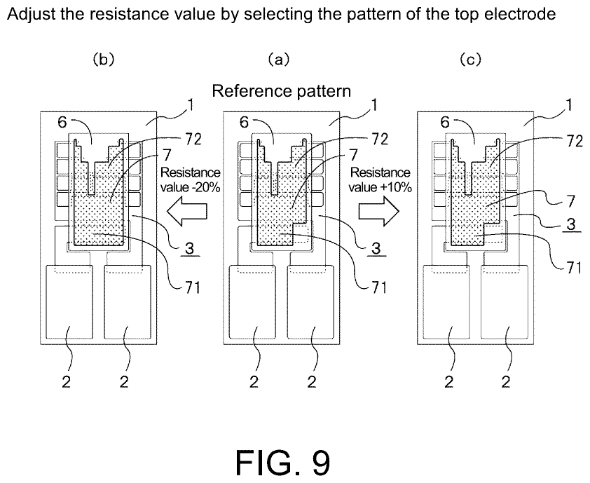

Next, the detailed configuration of the resistor 10 of this embodiment will be described with reference to FIG. 5 to FIG. 9, including a manufacturing method, specifically, a method for adjusting the resistance value by trimming. FIG. 5 is a graph showing the temperature of each part of the resistor, FIG. 6 is an explanatory diagram showing the relationship of the opposing area between the bottom electrode and the top electrode, and FIG. 7 is a graph showing the change rate of the resistance value due to a change in the opposing area between the bottom electrode and the top electrode. Further, FIG. 8 is a plan view showing a plurality of patterns of the top electrode, and FIG. 9 is an explanatory diagram showing the method of selecting the pattern of the top electrode to adjust the resistance value.

FIG. 5 shows data obtained by converting a temperature error from the result of measuring the temperature resistance characteristics of each part by connecting a lead wire to the terminal electrode 2 of the resistor 10 and applying electricity. The horizontal axis indicates the measured temperature [° C.] and the vertical axis indicates the temperature error [° C.]. “Required ΔT” is the temperature according to the required specifications of the resistor, “Element ΔTmax” is the maximum value of the temperature of the resistance body, “Element ΔTst” is the standard value of the temperature of the resistance body, and “Element ΔTmin” is the minimum value of the temperature of the resistance body. In addition, “+Wiring ΔTmax” is the maximum value of the temperature of the resistor considering the wiring pattern, “+Wiring ΔTst” is the standard value of the temperature of the same resistor, and “+Wiring ΔTmin” is the minimum value of the temperature of the same resistor.

It should be noted that the maximum value and the minimum value are converted values that take into account variations in characteristics, and the influence of the wiring resistance such as lead wire is ignored at this time.

From this result, it can be seen that the temperature of the resistor 6 in consideration of the temperature of the resistance body 6 and the wiring pattern in the resistor 10 of this embodiment is substantially within the temperature range according to the required specifications, and the error from the temperature according to the required specifications is small. Therefore, it can be confirmed that a highly accurate resistor 10 with little deviation from the resistance-temperature characteristic curve according to the required specifications can be realized. It is considered that since the wiring pattern in the region close to the terminal electrode 2 is configured to have a wider area and a lower resistance value than the wiring pattern in the region far away from the terminal electrode 2, the influence of the wiring resistance on the resistance value of the resistance body 6 can be suppressed.

FIG. 6 shows an example of a change in the opposing area between the bottom electrode and the top electrode. Specifically, with respect to the opposing area between the bottom electrode 3 and the top electrode 7, assuming that the portion of the crosspiece portion 432a of the bottom electrode 3 has a minimum area S, the portion of the crosspiece portion 432b is 2 times the minimum area S, the portion of the crosspiece portion 432c is 4 times the minimum area S, the portion of the crosspiece portion 432d is 8 times the minimum area S, the portion of the crosspiece portion 432e is 16 times the minimum area S, the portion of the crosspiece portion 432f is 32 times the minimum area S, the portion of the crosspiece portion 432g is 64 times the minimum area S, and the portion of the crosspiece portion 432h is 128 times the minimum area S. That is, the opposing area between the bottom electrode 3 and the top electrode 7 is set to be 2ⁿ (n=1, 2, 3, . . . ) times the minimum area S. Upon generalizing the relationship of the opposing area between the plurality of crosspiece portions (ladder portions) in the resistance adjustment pattern 43 of the bottom electrode 3 and the top electrode 3, when the minimum area of the opposing area is S and n is an integer, the opposing area Sₙ has the relationship Sₙ=S×2ⁿ.

In such a relationship of the opposing area between the bottom electrode 4 and the top electrode 7, for example, the resistance value can be adjusted by appropriately cutting the crosspiece portion 432b along the line B-B to cut off and trim the current supply, or cutting the crosspiece portion 432e along the line E-E to cut off and trim the current supply. In this case, there are 256 combinations of forms of cutting the crosspiece portions 432 by trimming, and the resistance value can be adjusted in 256 ways.

In such resistance value adjustment, the change rate of the resistance value due to trimming will be described with reference to FIG. 7. FIG. 7 is a graph showing the change rate of the resistance value, where the horizontal axis plots 256 changes in resistance value in ascending order of change rate, and the vertical axis indicates the change rate of the resistance value.

As shown in FIG. 7, it can be confirmed that the change rate of the resistance value is substantially linear. Therefore, it is possible to linearly adjust the resistance value by combining the forms in which the crosspiece portions 432 are cut.

Next, a plurality of patterns of the top electrode 7 will be described with reference to FIG. 8. FIG. 8 shows examples of the plurality of patterns of the top electrode 7. The plurality of patterns are film patterns prepared in advance by a sputtering method, etc., and are selected and formed from the plurality of patterns in order to adjust the resistance value.

(a) of FIG. 8 shows a form in which the area of the trimming pattern 71 in the top electrode 7 is wide, (b) of FIG. 8 shows a form in which a predetermined region at the lower right corner of the trimming pattern 71 is cut out and the area is reduced, and (c) and (d) of FIG. 8 show forms in which the cut-out region becomes narrower and the area of the trimming pattern 71 becomes wider. Therefore, the order of the forms according to the size of the area of the trimming pattern 71 is shown by the order of (a), (d), (c), and (b) of FIG. 8.

By forming a film selected from the plurality of patterns with different areas of the top electrode 7 in this way to form the top electrode 7, rough adjustment of the resistance value becomes possible.

Next, a method of adjusting the resistance value by selecting from among the plurality of patterns of the top electrode 7 will be described with reference to FIG. 9. (a) of FIG. 9 shows a case where the top electrode 7 of a reference pattern is formed (a pattern corresponding to (c) of FIG. 8), (b) of FIG. 9 shows a case where a pattern in which the area of the trimming pattern 71 is wider than the top electrode 7 of the reference pattern is selected (a pattern corresponding to (a) of FIG. 8), and (c) of FIG. 9 shows a case where a pattern in which the area of the trimming pattern 71 is narrower than the top electrode 7 of the reference pattern is selected (a pattern corresponding to (b) of FIG. 8).

Therefore, for example, in the pattern of (b) of FIG. 9, the resistance value can be lowered by 20% compared to the reference pattern, and in the pattern of (c) of FIG. 9, the resistance value can be increased by 10% compared to the reference pattern, and the resistance value can be adjusted both in the higher and lower directions.

It should be noted that the selection of the pattern of the top electrode 7 is performed by measuring the resistance value between the terminal electrode 2, that is, the resistance value between the first electrode pattern 4 and the second electrode pattern 5 of the bottom electrode 3, before selecting and forming the top electrode 7, and predicting the resistance value after forming the top electrode 7.

The method of adjusting the resistance value of the resistor 10 as described above includes: preparing in advance a plurality of patterns for the top electrode 7, and selecting the top electrode 7 of a desired pattern from the plurality of patterns of the top electrode 7 to adjust the resistance value; and cutting the resistance adjustment pattern 43 of the bottom electrode 3 to adjust the resistance value.

The resistor 10 described above can be suitably provided and applied to various devices that require highly accurate control, such as the medical field, in-vehicle devices such as automobiles, and home appliances. There is no particular limitation on the devices to which the present invention is applied.

It should be noted that the present invention is not limited to the configurations of the above embodiments, and various modifications may be made without departing from the gist of the invention. Further, the above embodiments are presented as examples, and are not intended to limit the scope of the invention. These novel embodiments may be implemented in various other forms, and various omissions, substitutions, and changes can be made. These embodiments and their modifications are included within the scope and gist of the invention, as well as within the scope of the invention described in the claims and its equivalent.

Furthermore, when the resistor of the present invention is applied as a current sensor, a four-terminal structure may be used to more accurately measure the current value. Similarly, when measuring temperature, a four-terminal structure makes it possible to more accurately measure the temperature.

### REFERENCE SIGNS LIST

1 . . . insulating substrate
11 . . . insulating film
2 . . . terminal electrode
3 . . . bottom electrode
4 . . . first electrode pattern
41 . . . connection pattern
42 . . . main electrode pattern
43 . . . resistance adjustment pattern
432 . . . crosspiece portion (ladder portion)
5 . . . second electrode pattern
51 . . . connection pattern
52 . . . main electrode pattern
6 . . . resistance body
7 . . . top electrode
71 . . . trimming pattern
72 . . . opposing pattern
8 . . . protective film
10 . . . resistor

1. A resistor, comprising:
an insulating substrate;
a terminal electrode formed on the insulating substrate;
a bottom electrode formed on the insulating substrate, connected to the terminal electrode, and comprising a resistance adjustment pattern, wherein a pattern in a region close to the terminal electrode has lower resistance than a pattern in a region far from the terminal electrode;
a resistance body formed on the bottom electrode; and
a top electrode formed on the resistance body and arranged to face the bottom electrode.

2. The resistor according to claim 1, wherein the resistance body is a metal oxide.

3. The resistor according to claim 1, wherein the resistance body is a metal nitride.

4. The resistor according to claim 1, wherein the resistance body is a metal film.

5. The resistor according to claim 1, wherein the resistance body is a thin film thermistor.

6. The resistor according to claim 1, wherein the top electrode has a pattern in a region close to the terminal electrode, which has lower resistance than a pattern in a region far from the terminal electrode.

7. The resistor according to claim 1, wherein the resistance adjustment pattern in the bottom electrode comprises a plurality of ladder portions arranged to face each other in pairs.

8. The resistor according to claim 7, wherein the plurality of ladder portions have areas different from each other.

9. The resistor according to claim 7, wherein the plurality of ladder portions in the resistance adjustment pattern and the top electrode are arranged to face each other, and a relationship of an opposing area between the plurality of ladder portions and the top electrode is as follows,
opposing area Sₙ has a relationship of Sₙ=S×2ⁿ,
where a minimum area of the opposing area is S and n is an integer.

10. A device, comprising a resistor, wherein the device comprises the resistor according to claim 1.

11. A method of manufacturing the resistor according to claim 1, the method comprising:
preparing in advance a plurality of patterns for the top electrode, and selecting the top electrode of a desired pattern from the plurality of patterns of the top electrode to adjust a resistance value; and
cutting the resistance adjustment pattern of the bottom electrode to adjust the resistance value.
